(19) United States
(12) Patent Application Publication
(10) Pub. No.: US 2011/0223824 A1
(43) Pub. Date: Sep. 15, 2011

(54) FLAME-RETARDANT COMPOSITIONS AND RELATED PROCESSES, FABRICS, TEXTILES, PLASTICS, AND ARTICLES OF MANUFACTURE

(76) Inventor: Charles ARNOLDI, Mahwah, NJ (US)

(21) Appl. No.: 12/720,459

(22) Filed: Mar. 9, 2010

(51) Int. Cl. B32B 5/02; C08K 3/32; B32B 27/08

(52) U.S. Cl. 442/142; 524/416; 428/500

(57) ABSTRACT

The invention relates to flame-retardant compositions and related processes, fabrics, and textiles. Flame retardant compositions of the invention are anionic, exhibit superior durability, have a solids content and particle size that is particularly advantageous for fabric and textile manufacturing, exceed the flammability standards imposed by NFPA Standard 701 or NFPA Standard 705, and prove non-toxic over prolonged periods of exposure. Significantly, flame retardant compositions of the invention incorporate, and are made by processes that use, ammonium polyphosphate.

### FIELD OF THE INVENTION

The invention relates to flame-retardant compositions and related processes, fabrics, textiles, plastics, and related articles of manufacture. Fabrics, textiles, plastics, and related articles of manufacture which are treated by or which incorporate compositions of the invention satisfy or exceed NFPA-701, preferably (in the case of textiles), NFPA-705 standards.

### BACKGROUND OF THE INVENTION

The flammability of fabrics is typically determined by the nature of the fiber comprising the fabric. For example, some synthetic fibers, such as melamine, polyaramides, carbonized acrylic, and glass, are inherently flame resistant, whereas others such as cotton, polyester and linen, can readily ignite and exhibit a degree of flammability that varies according to fiber type and characteristics. The bum rate and temperature of a textile made from a blend of fibers are usually greater than the burn rate and temperature of each of the textile's composite fibers. Fabric flammability also depends on the fabric thickness and/or looseness. See U.S. Pat. No. 7,504,449.

Commercial textile products are usually required by law to have smoke suppressant and flame retardant properties in order to help prevent smoke generation and flame spread through the textile products in the event of a fire. For example, National Fire Protection Association (NFPA) Standard 701 and NFPA 705 specifies methods for fire tests that assess flame propagation in textiles and films and provides an accepted methodology for evaluating whether a fabric or textile has a an acceptable flammability profile.

Efforts to satisfy applicable fire safety standards by treating fabrics or textiles with compositions such as decabromodiphenyl ether or other flame retardants such as antimony trioxide and alumina trihydrate have proven unsatisfactory, since humans (particularly children) can suffer adverse effects from prolonged exposure to such flame retardants. While halogen-free flame retardants comprising ammonium and sodium salts of phosphoric acid would appear to offer the advantage of lower toxicity, their use with fabrics and textiles has been hindered by drawbacks such as poor performance in the presence of moisture. See U.S. Pat. No. 6,617,382.

Accordingly, the need exists for improved flame-retardant compositions and related processes, fabrics, textiles, plastics, and related articles of manufacture that satisfy applicable fire safety standards, that are readily manufactured or implemented, and that prove non-toxic over prolonged periods of exposure.

### SUMMARY OF THE INVENTION

In one aspect, the invention provides a flame-retardant composition (preferably substantially non-toxic and preferably as aqueous dispersions) made by a process comprising reacting the following reactants in an aqueous reaction medium (totals construed as percentages by weight of final aqueous reaction mixture):

(a) about 6 weight % to about 10 weight %, more preferably about 7 weight % to about 10 weight %, or even more preferably about 7.75 weight % to about 8.0 weight %, and most preferably about 7.75 weight %, of a heptyl, octyl or nonyl phenol ethoxylate (“a C₇-C₉ alkyl phenol ethoxylate”), preferably octyl or nonylphenol ethoxylate (“C₈-C₉ alkyl phenol ethoxylate”), more preferably nonylphenol ethoxylate that contains from 1 to 20, or more preferably from 1 to 12, and most preferably 9-12, moles of ethylene oxide;
(b) about 1 weight % to about 5 weight %, or more preferably about 2 weight % to about 5 weight %, or even more preferably about 2.5 weight % to about 2.85 weight %, and most preferably about 2.84 weight %, of at least one phosphate ester;
(c) about 1 weight % to about 40 weight %, or more preferably about 2 weight % to about 35 weight %, or about 2 weight % to about 32 weight %, or about 2 weight % to about 20 weight %, or about 2 weight % to about 40 weight %, or about 2 weight % to about 50 weight %, or about 2 weight % to about 40 weight %, or about 2 weight % to about 30 weight %, or about 20 weight % to about 28 weight %, and most preferably about 23.17% to about 25.17 weight %, of an ammonium polyphosphate of the formula [NH₄ PO₃]_{z}, where z is less than 10,000, or more preferably is a value from 20 to 1,000, or even more preferably is a value from 500 to 1,000;
(d) about 0.05% to about 5%, about 0.1 weight % to about 3-5 weight %, or about 0.5 weight % to about 2.5 weight %, or about 1.6 weight % to about 2.0 weight %, of an acrylic emulsion copolymer; and
(e) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which amount generally ranges (for a 28% by weight ammonia solution) from about 0.25 weight % to about 0.35 weight %, about 0.25 weight % to about 0.30 weight %, or about 0.28 weight %, of ammonia;
wherein the weight percentage of water in the aqueous reaction medium relative to the total weight percentages of reactants (a)-(e) is between about 35 weight % to about 75 weight %, about 40 weight % to about 70 weight %, or even more preferably is about 55 weight % to about 65 weight %, or most preferably is about 40 weight % to about 60 weight %.

Flame retardant compositions of the invention are anionic, exhibit superior durability, have a solids content and particle size that is particularly advantageous for fabric and textile manufacturing (preferably, about 40% solids content and a particle size of less than about 4 millimeters when measured by a Hegman gauge), exceed the flammability standards imposed by NFPA Standard 701, preferably NFPA Standard 705, and prove non-toxic over prolonged periods of exposure. Significantly, flame retardant compositions of the invention incorporate, and are made by processes that use, ammonium polyphosphate, a non-toxic flame retardant which has previously exhibited thermal instability and poor dispersion when used with fabrics and textiles.

In certain aspects, the invention provides a flame-retardant composition made by a process comprising reacting the following reactants in an aqueous reaction medium:

(a) about 6 weight % to about 10 weight %, more preferably about 7 weight % to about 10 weight %, or even more preferably about 7.5 weight % to about 8.5 weight %, and most preferably about 7.5 weight % of a C₇-C₉ alkyl phenol ethoxylate, preferably octyl or nonylphenol ethoxylate, more preferably nonylphenol ethoxylate which contains between about 9 to 12 moles of ethylene oxide, and most preferably a nonyl phenol ethoxylate which contains 9 moles of ethylene oxide);
(b) about 1 weight % to about 5 weight %, or more preferably about 2 weight % to about 5 weight %, or even more preferably about 2.5 weight % to about 2.85 weight %, and most preferably about 2.84 weight %, of at least one phosphate ester formed by phosphating (1) an alkyl phenyl ethoxylate (e.g. phosphating a nonyl phenol ethoxylate, a heptyl phenol ethoxylate, an octyl phenol ethoxylate, or a dodycyl phenol ethoxylate (preferably, phosphating a nonyl phenol ethoxylate)) and/or (2) an alcohol ethoxylate of the formula:

CH₃(CH₂)ₓO(CH₂CH₂O)_{y}H

where x is a value from 1 to 50, or more preferably is a value from 5 to 15, and y is a value from 1 to 20, or more preferably is a value from 5 to 10; and
(c) about 1 weight % to about 40 weight %, or more preferably about 2 weight % to about 35 weight %, or even more preferably about 2 weight % to about 32 weight %, or even more preferably about 2 weight % to about 20 weight %, or even more preferably about 2 weight % to about 10 weight %, or even more preferably about 2 weight % to about 5 weight %, or even more preferably about 2 weight % to about 1.0 weight %, or even more preferably about 2 weight % to about 5 weight %, or even more preferably about 25 weight % to about 28.5 weight %, and most preferably about 25.17 weight %, of a Phase II ammonium polyphosphate of the formula [NH₄ PO₃]_{z}, where z is a value from 20 to 1,000, or is more preferably is a value from 500 to 1,000;
(d) about 1.0 weight % to about 3 weight %, or even more preferably about 1.5 weight % to about 2.5 weight %, or most preferably about 1.6 weight % to about 2 weight %, of an acrylic emulsion copolymer that comprises an aqueous suspension of a linear copolymer of methacrylic acid and acrylic and methacrylic acid esters and that has a molecular weight of several million; and
(e) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution); wherein the weight percentage of water in the aqueous reaction medium relative to the total weight percentages of reactants (a)-(e) is between about 40 weight % to about 70 weight %, or even more preferably about 55 weight % to about 65 weight %, or most preferably about 40 weight % to about 60 weight %.

In another aspect, the invention provides a flame-retardant composition made by a process comprising reacting the following reactants in an aqueous reaction medium:

(a) about 7 weight % to about 8 weight % of a C₇-C₉ alkyl phenol ethoxylate, preferably octyl or nonylphenol ethoxylate, more preferably nonylphenol ethoxylate which contains between about 9 to 12 moles of ethylene oxide;
(b) about 2 weight % to about 3 weight % of a phosphate ester selected from the group consisting of a monodecyl phosphate ester, didecyl phosphate ester, and tridecyl phosphate ester, wherein the monodecyl phosphate ester, didecyl phosphate ester, and tridecyl phosphate ester each contain from 5 to 10 moles of ethylene oxide;
(c) about 20 weight % to about 50 weight % of a Phase II ammonium polyphosphate of the formula [NH₄ PO₃]_{z}, where z is a value from 20 to 1,000, or is more preferably is a value from 500 to 1,000;

(d) about 1.5 weight % to about 2.5 weight % of an acrylic emulsion copolymer that comprises an aqueous suspension of a linear copolymer of methacrylic acid and acrylic and methacrylic acid esters and that has a molecular weight of several million; and

(e) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution);
wherein the weight percentage of water in the aqueous reaction medium relative to the total weight percentages of reactants (a)-(e) is between about 40 weight % to about 60 weight %.

In a preferred aspect, the invention provides a flame-retardant composition made by a process comprising reacting the following reactants in an aqueous reaction medium:

(a) about 7.5 weight % of a nonyl phenol ethoxylate containing about 9 moles of ethylene oxide;
(b) about 2.85 weight % of a monodecyl phosphate ester which contains 6 moles of ethylene oxide;
(c) about 25 weight % of a Phase II ammonium polyphosphate of the formula [NH₄ PO₃]_{z}, where z is a value from 20 to 1,000, or is more preferably is a value from 500 to 1,000;
(d) about 1.5 weight % to about 2.0 weight % of ACRYSOL® ASE 95 or ACRYSOL® ASE 60;and
(e) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution);
wherein the weight percentage of water in the aqueous reaction medium relative to the total weight percentages of reactants (a)-(e) is between about 40 weight % to about 60 weight %.

In a preferred aspect which is particularly useful for heavily constructed cotton fabrics, the invention provides a flame-retardant composition made by a process comprising reacting the following reactants in an aqueous reaction medium:

(a) about 7.70 weight % of a nonyl phenol ethoxylate containing about 9 moles of ethylene oxide;
(b) about 2.8 weight % of a monodecyl phosphate ester which contains 9.5 moles of ethylene oxide;
(c) about 32 weight % of a Phase II ammonium polyphosphate of the formula [NH₄ PO₃]_{z}, where z is a value from 20 to 1,000, or is more preferably is a value from 500 to 1,000;
(d) about 1% of a decyl phosphate ester containing 6 moles of ethylene oxide,
(e) about 1.5 weight % to about 2.0 weight % of ACRYSOL® ASE 95 or ACRYSOL® ASE 60; and
(f) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution);
wherein the weight percentage of water in the aqueous reaction medium relative to the total weight percentages of reactants (a)-(e) is between about 40 weight % to about 60 weight %.

One example of how the above-described processes can be implemented to make a flame-retardant composition of the invention involves:

(a) heating water in a reaction vessel to a temperature of greater than about 95° F. to about 100° F.;
(b) thereafter, adding to the heated water in the reaction vessel a nonyl phenol ethoxylate containing about 9 moles of ethylene oxide and agitating the mixture of heated water and nonylphenol ethoxylate until the mixture is clear;
(c) thereafter, adding to the clear mixture of heated water and nonyl phenol ethoxylate a phosphate ester (e.g. a monodecyl phosphate ester which contains 6 moles of ethylene oxide) and agitating the resultant mixture;
(d) thereafter, adding an ammonium polyphosphate of the formula [NH₄ PO₃]_{z}, (where the ammonium polyphosphate is preferably a Phase II ammonium polyphosphate and z is less than 10,000, or preferably is a value from 20 to 1,000, or even more preferably is a value from 500 to 1,000) to the mixture of monodecyl phosphate ester, heated water and nonyl phenol ethoxylate, wherein the combination of ammonium polyphosphate, phosphate ester, heated water and nonyl phenol ethoxylate is agitated to form a dispersion;
(e) thereafter, under continuous agitation, adding a an acrylic emulsion copolymer that comprises an aqueous suspension of a linear copolymer of methacrylic acid and acrylic and methacrylic acid esters and that has a molecular weight of several million to the dispersion of ammonium polyphosphate, phosphate ester, heated water and nonyl phenol ethoxylate; and
(f) thereafter, adding ammonia to the acrylic emulsion copolymer -containing dispersion of ammonium polyphosphate, phosphate ester, heated water and nonylphenol ethoxylate.

In a particularly preferred aspect, the invention provides a flame-retardant composition made by a process comprising reacting the following reactants in an aqueous reaction medium:

(a) about 7.75 weight % of a nonyl phenol ethoxylate containing about 9 moles of ethylene oxide;
(b) about 2.84 weight % of a monodecyl phosphate ester which contains about 6 moles of ethylene oxide;
(c) about 25.17 weight % of a Phase II ammonium polyphosphate of the formula [NH₄ PO₃]_{z}, where z is a value from 20 to 1,000, or is more preferably is a value from 500 to 1,000;
(d) about 1.6 weight % of ACRYSOL® ASE 95; and
(e) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution);
wherein the weight percentage of water in the aqueous reaction medium relative to the total weight percentages of reactants (a)-(e) is between about 40 weight % to about 60 weight %.

As described above, a preferred aspect includes a flame-retardant composition made by a process comprising

(a) heating water in a reaction vessel to a temperature of greater than about 95° F. to about 100° F.;
(b) thereafter, adding a C₇-C₉ alkyl phenol ethoxylate, preferably nonyl phenol ethoxylate containing about 9-12 moles, preferably 9 moles of ethylene oxide to the heated water in the reaction vessel and agitating the mixture of heated water and alkyl phenol ethoxylate, preferably nonyl phenol ethoxylate until the mixture is clear;
(c) thereafter, adding to the clear mixture of heated water and nonyl phenol ethoxylate a monodecyl phosphate ester which contains 6 moles of ethylene oxide and agitating the resultant mixture;
(d) thereafter, adding a Phase II ammonium polyphosphate of the formula [NH₄ PO₃]_{z}, where z is a value from 20 to 1,000 (or more preferably is a value from 500 to 1,000), to the mixture of monodecyl phosphate ester, heated water and nonyl phenol ethoxylate, wherein the combination of ammonium polyphosphate, monodecyl phosphate ester, heated water and nonyl phenol ethoxylate is agitated to form a dispersion;
(e) thereafter, under continuous agitation, adding ACRYSOL® ASE 95 to the dispersion of ammonium polyphosphate, monodecyl phosphate ester, heated water and alkyl phenol ethoxylate, preferably nonyl phenol ethoxylate; and
(f) thereafter, adding ammonia to the ACRYSOL® ASE 95-containing dispersion of ammonium polyphosphate, monodecyl phosphate ester, heated water and nonyl phenol ethoxylate.

In the preferred processes described above, before adding the acrylic emulsion copolymer, about 0.01 weight % to about 3 weight %, about 0.025 weight % to about 2 weight %, about 0.5 weight % to about 1 weight %, about 1 weight %, about 0.02 weight % to about 0.05 weight %, about 0.025 weight % to about 0.1 weight % of a phosphated alkyl phenol ethoxylate (e.g. phosphated nonyl phenol ethoxylate, phosphated heptyl phenol ethoxylate, phosphated octyl phenol ethoxylate, or phosphated dodecyl phenol ethoxylate (preferably, phosphated nonyl phenol ethoxylate) can be added to the dispersion of ammonium polyphosphate, monodecyl phosphate ester, heated water and nonyl phenol ethoxylate to reduce foaming.

In further preferred processes described above, an effective amount of a viscosity reducing agent, for example, diammonium phosphate or ammonium sulfate (e.g., an effective amount within the range of less than about 1% to about 6% or more, about 1-6%, about 2-5%, about 3-4% as needed) by weight added as a solid or aqueous solution/dispersion) may be added to the composition during any step where elevated viscosity becomes an issue for processing, but preferably is added in the step in the step in the process before the addition of ammonium polyphosphate in order to reduce viscosity to facilitate mixing of the ammonium polyphosphate and ultimately, the delivery of final composition for storage or transport. In addition, a small amount of diammonium phosphate (about 0.1% to about 10%, about 0.25% to about 7.5%, about 0.5% to about 5%, about 0.75% to about 2.5%, about 1% to about 3.5% by weight) in place of or as a supplement to ammonium polyphosphate optionally may be added to the composition in order to reduce the viscosity of the final formulation.

Related processes and flame-retardant fabrics and textiles are also provided by the invention, which is described further in the following detailed description.

### DETAILED DESCRIPTION OF THE INVENTION

The following definitions apply unless indicated otherwise.

“C₇-C₉ alkyl phenol ethoxylate”, preferably “Nonyl phenol ethoxylates” used in the invention are nonionic surfactants. Preferred alkyl phenol ethoxylates include nonyl phenol ethoxylates such as TERGITOL® NP-9 (Dow Chemical Corp., Midland Mich.) which contains about 9 moles of ethylene oxide (alkyl phenol ethoxylates preferably contain about 9-12 moles of ethylene oxide). Preferably, flame retardant compositions of the invention are made by reacting 7 weight % to about 8 weight % of a nonyl phenol ethoxylate as described above. This weight percentage range ensures an acceptable viscosity, minimizes foam, and keeps the end product in suspension.

“Phosphate esters” are surfactants formed by phosphating alkyl phenyl ethoxylates, alcohol ethoxylates, or alcohol propoxylates. Phosphate esters used in the invention ensure that ammonium polyphosphate is dispersed, contribute to the flame retardant characteristics of the compositions of the invention, aid in dispersing compositions of the invention on or within fabrics or textiles, and, in combination with the acrylic emulsion copolymer, enable compositions of the invention to be applied by an exhaustion method. In certain embodiments, phosphate esters can comprise complex mixtures of monoesters and diesters of linear fatty alcohols. Useful phosphate esters include, but are not limited to, Decyl 2.5 EO phosphate, Decyl 6.0 EO phosphate, Decyl 8.0 EO phosphate, Tridecyl 6.5 EO phosphate, Myristyl 3.0 EO phosphate, Myristyl 7.0 EO phosphate, Myristyl 9.0 EO phosphate, and Myristyl 12.0 EO phosphate.

Preferred phosphate esters are formed by phosphating an alkyl phenyl ethoxylate and/or an alcohol ethoxylate of the formula:

CH₃(CH₂)ₓO(CH₂CH₂O)_{y}H

where x is a value from 1 to 50, or more preferably is a value from 5 to 15, and y is a value from 1 to 20, or more preferably is a value from 5 to 10, or even more preferably is 6. Ultraphos 6.0 EO phosphate (MFG Chemical) is a preferred phosphate ester.

“An ammonium polyphosphate of the formula [NH₄ PO₃]_{z}, where z is less than 10,000” includes, but is not limited to, Exolit® AP 422 brand ammonium polyphosphate (Clariant GmbH, Frankfurt am Main, Germany), which is a free-flowing, pulverulent, low-water-solubility, Phase II ammonium polyphosphate of the formula [NH₄ PO₃]_{z}, where z is a value from 20 to 1,000, or is more preferably is a value from 500 to 1,000. The proportion of particles with particle size less than 45 μm is more than 99%. Phase II ammonium polyphosphate is preferred because Phase II ammonium polyphosphate is slightly more water soluble than Phase I ammonium polyphosphate. This allows more ammonium polyphosphate to be absorbed on a fabric or textile upon curing. The added ammonia also slightly shortens ammonium polyphosphate chain length and adds to solubility. The two free bonds of ammonium polyphosphate contribute to the durability of the end product.

As described above, in processes and resultant compositions of the invention, the amount of ammonium polyphosphate may be increased to as much as about 35 weight % (more preferably, as much as about 32 weight %) by using 7.75 weight % of a phosphate ester which contains about 9.5 moles of ethylene oxide.

“Acrylic emulsion copolymers” are acrylic polymers which contain hydrophilic groups (e.g. carboxylic groups) that make the polymers readily dispersible in water. When in the form of an aqueous latex, acrylic emulsion copolymers act as thickeners of aqueous systems and form a milky latex with water at acid pH values and a clear gel with water at neutral or alkaline pH values. The acrylic polymer latex is desirably one which contains some free carboxyl groups. Preferred acrylic emulsion copolymers include ACRYSOL® ASE 95 or ACRYSOL® ASE 60 (Dow Chemical Corp., Midland, Mich.). ACRYSOL® ASE 95 is particularly preferred and readily dissolves or disperses to form a clear highly viscous system in an alkaline solution. ACRYSOL® ASE 95 is believed to be a 20% aqueous suspension of a linear copolymer of methacrylic acid and acrylic and methacrylic acid esters with a molecular weight of several million. On neutralizing with alkali it exhibits an equivalent weight of 123.5. At a pH of about 3.0 the suspension is milky and on addition of alkali the milkiness is gradually reduced until a clear viscous liquid is obtained when the pH is just greater than 7.0. Copolymers of at least one from the group methacrylic acid and acrylic acid, with at least one from the group lower alkyl acrylates and lower alkyl methacrylates (particularly methyl and ethyl) are desirable polymer materials for the latex. See U.S. Pat. No. 4,097,405. Acrylic emulsion copolymers such as ACRYSOL® ASE 95, when added during the manufacturing process described below, hold the dispersion in suspension and add to the durability of the end product. The product pH of about 9.0 also helps to minimize phase separation.

A “flame retardant” is a compound, composition, or formulation that is capable of reducing or eliminating the tendency of a substance to ignite when exposed to a low-energy flame. A flame retardant composition of the invention satisfies or exceeds the standards specified in National Fire Protection Association (NFPA) Standard 701 and/or 705. Flame retardant compositions according to the present invention are substantially non-toxic, ie., they exhibit a toxicity which is substantially diminished in comparison to traditionally used fabric flame retardants.

The term “fiber” refers to a natural or synthetic filament capable of being spun into a yarn or made into a fabric. The terms “fabric”, “textile” and “textile fabric” are used interchangeably to describe a sheet structure made from fibers. Non-limiting examples of products that can incorporate flame-retardant compositions of the invention include articles of clothing, draperies, carpets, linens, mattresses, and furniture.

A flame retardant composition of the invention may be applied to, or incorporated within, a fabric, textile, plastic, or article of manufacture (e.g. furniture, home appliance, personal computer, etc.) in a wide variety of ways. For example, an exhaustion process may be used in which the fabric or textile is immersed in a heated bath (e.g., a bath at a temperature from 110° C. to 140° C.) containing a flame retardant composition of the invention, whereby the fabric or textile fibers incorporate the flame retardant composition by exhaustion. Alternatively, a flame retardant composition of the invention can sprayed or coated onto a fabric, textile, plastic, or article of manufacture (e.g. a polyester-based fiber product) and the fabric, textile, plastic, or article of manufacture can be heat-treated (e.g., at a temperature from 170° C. to 220° C.), causing the fabric, textile, plastic, or article of manufacture to incorporate the flame retardant composition by exhaustion.

In a preferred aspect, the invention provides a flame-retardant composition which is made by a process comprising reacting the following reactants in the aqueous reaction medium:

(a) about 7.75 weight % of a nonyl phenol ethoxylate containing about 9 moles of ethylene oxide;
(b) about 2.85 weight % of a monodecyl phosphate ester which contains 9.5 moles of ethylene oxide;
(c) about 25 weight % of a Phase II ammonium polyphosphate of the formula [NH₄ PO₃]_{z}, where z is a value from 20 to 1,000, or is more preferably is a value from 500 to 1,000;
(d) about 1% of a phosphate nonylphenol containing 6 mols of ethylene oxide,
(e) about 1.5 weight % to about 2.0 weight % of ACRYSOL® ASE 95 or ACRYSOL® ASE 60; and
(f) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution);
and wherein the weight percentage of water in the aqueous reaction medium relative to the total weight percentages of reactants (a)-(e) is between about 40 weight % to about 60 weight %.

In another preferred aspect, the invention provides an anionic, flame-retardant composition which has a pH of about 9.5 and which is made by a process comprising reacting the following reactants in the aqueous reaction medium:

(a) about 7.75 weight % of a nonyl phenol ethoxylate containing about 9 moles of ethylene oxide;
(b) about 2.84 weight % of a monodecyl phosphate ester which contains 6 moles of ethylene oxide;
(c) about 25 weight % of a Phase II ammonium polyphosphate of the formula [NH₄ PO₃]_{z}, where z is from 20 to 1,000, or is more preferably 500 to 1,000;
(d) about 1% of a decyl phosphate ester containing 6 mols of ethylene oxide,
(e) about 1.5 weight % to about 2.0 weight % (preferably, about 1.6 weight %) of ACRYSOL® ASE 95; and
(f) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution);
wherein the weight percentage of water in the aqueous reaction medium relative to the total weight percentages of reactants (a)-(e) is between about 40 weight % to about 60 weight %.

In another preferred aspect, the invention provides an anionic, flame-retardant composition which has a pH of about 9.5 and which is made by a process consisting essentially of reacting the following reactants in the aqueous reaction medium:

(a) about 7.75 weight % of a nonyl phenol ethoxylate containing about 9 moles of ethylene oxide;
(b) about 2.84 weight % of a monodecyl phosphate ester which contains 6 moles of ethylene oxide;
(c) about 25 weight % of a Phase II ammonium polyphosphate of the formula [NH₄ PO₃]_{z}, where z is from 20 to 1,000, or is more preferably 500 to 1,000;
(d) about 1.5 weight % to about 2.0 weight % of ACRYSOL® ASE 95; and
(e) an amount of an aqueous ammonia solution (preferably comprising about 22% to about 40% by weight ammonia in water, preferably about 28% by weight ammonia in water) effective to neutralize the final composition to a pH of at least about 8.5, about 8.5 to about 10, about 8.5 to about 9.5, about 9.0 to about 9.5, which preferably represents about 0.25 weight % to about 0.35 weight %, or even more preferably about 0.25 weight % to about 0.30 weight %, or most preferably about 0.30 weight %, of concentrated ammonia solution (about 28% by weight ammonia in solution);
wherein the weight percentage of water in the aqueous reaction medium relative to the total weight percentages of reactants (a)-(e) is between about 40 weight % to about 60 weight %.

The invention includes each of the processes that are described above and that are used to make the flame-retardant compositions claimed herein.

The invention is described further in the following examples, which are exemplary and non-limiting.

### EXAMPLE 1

### Process for Making a Flame-retardant Composition

A flame-retardant composition of the invention can be made by a process comprising:

(a) heating about 2,900 pounds to about 3,000 pounds of water in a reaction vessel to a temperature of greater than about 95° F.;
(b) thereafter, adding to the heated water in the reaction vessel about 370 pounds of a nonyl phenol ethoxylate containing about 9 moles of ethylene oxide and agitating the mixture of heated water and nonyl phenol ethoxylate until the mixture is clear;
(c) thereafter, adding to the clear mixture of heated water and nonyl phenol ethoxylate about 15 gallons of a monodecyl phosphate ester which contains 6 moles of ethylene oxide and agitating the resultant mixture for about 10 to about 15 minutes;
(d) thereafter, adding about 1,200 pounds of an ammonium polyphosphate having a Phase II crystalline structure to the mixture of monodecyl phosphate ester, heated water and nonyl phenol ethoxylate, wherein the combination of ammonium polyphosphate, monodecyl phosphate ester, heated water and nonyl phenol ethoxylate is agitated to form a dispersion;
(e) thereafter, under continuous agitation, adding about 75 pounds of ACRYSOL® ASE 95 to the dispersion of ammonium polyphosphate, monodecyl phosphate ester, heated water and nonyl phenol ethoxylate; and
(f) thereafter, adding about 14 pounds of ammonia to the ACRYSOL® ASE 95-containing dispersion of ammonium polyphosphate, monodecyl phosphate ester, heated water and nonyl phenol ethoxylate.

### EXAMPLE 2

### Mixing Procedures for Dispersing Ammonium Polyphosphate

1. Charge 2,970 lbs of water into tank. Heat water to 100° F. (354 gallons). After water temperature has reached greater than 95° F., cut heat source off.
2. Start agitation at low RPM setting. Verify the water temperature has not dropped below 95° F. before moving to step 3.
3. Slowly add 370 lbs of NP-9 (40 gal). Must add slowly to minimize foam. Continue agitating until solution is clear.
Let mix for 15-20 minutes. Do not forego mix time before starting on next step.
4. Add 15 gallons of decyl phosphate ester. Must add slowly to minimize foam. Continue to agitate for approx. 10 minutes (135 pounds)
5. Under good agitation, slowly sift in 1,200 pounds of ammonium polyphosphate. Let mix agitate for approximately 20 minutes after charging the APP. Increase agitation to high RPM speed to ensure complete dispersion.
6. Very slowly add 45 Pounds phosphated nonyl phenyl 9
Take sample to lab to have particle size tested. Hegman gauge
6. Slowly add 8 gallons of ASE-95 (75 pounds). Continue to agitate.
7. Charge 14 pounds of Aqua Ammonia. This should raise the pH to approximately 9.5 (2 gallons)
Continue to agitate for 60 minutes and pull a sample. Submit to lab for testing. Decrease agitation to low RPM setting after the 60 minutes until it is ready to be taken out of the tank. The sample should contain about 40% solids.

### EXAMPLE 3

### Reduced Viscosity Composition

Following the general method of example 2, the following steps are provided, with variation to reduce viscosity in the final formula.
1. Water is heated in a mixing vessel to 95-100° F.
2. Thereafter, adding to the heated water in the vessel is octylphenol ethoxylate with 12 moles of ethylene oxide through low agitation until clear.
3. Thereafter, under agitation, adding to the clear mixture of water and octyl phenol ethoxylate, a phosphate ester with 6 moles ethylene oxide.
4. Thereafter, adding ammonium sulfamate to the mixture;
5. Thereafter, adding diammonium phosphate to the mixture;
6. Thereafter, adding a phase II ammonium polyphosphate to the mixture;
7. Thereafter, adding a phosphate ester with 9 moles of ethylene oxide;
8. Adding methyl acrylate thickener to the mixture; and finally;
9. Adding aqueous ammonia (28% by weight) to neutralize the composition to a final pH of about 9.0.

The amount of APP is approximately 23% by weight. The amount of Ammonium sulfate used is approximately 3.4%. 3.1% by weight diammonium phosphate is added as a viscosity reducer. ASE-95 is increased to about 0.25% and a slight increase in ammonia to produce a final pH of about 9.0.

1. A flame-retardant composition made by a process comprising reacting the following reactants in an aqueous reaction medium:
(a) about 6 weight % to about 10 weight % of a C₇-C₉ alkyl phenol ethoxylate, preferably nonyl phenol ethoxylate that contains between about 1 to about 20 moles of ethylene oxide;
(b) about 1 weight % to about 5 weight % of a phosphate ester;
(c) about 1 weight % to about 40 weight % of an ammonium polyphosphate of the formula [NH₄ PO₃]_{z}, where z is less than 10,000;
(d) about 0.05 weight % to about 5 weight % of an acrylic emulsion copolymer; and
(e) an amount of an aqueous ammonia solution effective to neutralize the final composition to a pH of at least about 8.5; wherein the weight percentage of water in the aqueous reaction medium relative to the total weight percentages of reactants (a)-(e) is between about 45 weight % to about 75 weight %.

2. The flame-retardant composition of claim 1, wherein the flame-retardant composition is made by a process comprising reacting:
(a) about 7 weight % to about 10 weight %, or about 7.5 weight % to about 8.5 weight %, or about 7.75 weight % of nonyl phenol ethoxylate;
(b) about 2 weight % to about 5 weight %, or about 2.5 weight % to about 2.85 weight %, or about 02.84 weight %, of the phosphate ester;
(c) about 20 weight % to about 35 weight %, or about 20 weight % to about 32 weight %, or about 20 weight % to about 20 weight %, or about 2 weight % to about 100 weight %, or about 20 weight % to about 50 weight %, or about 20 weight % to about 100 weight %, or about 20 weight % to about 50 weight %, or about 25 weight % to about 28.5 weight %, or about 25.17 weight %, of the ammonium polyphosphate;
(d) about 1.0 weight % to about 2.5 weight %, or about 1.6 weight % to about 2 weight %, of the acrylic emulsion copolymer;
(e) an amount of an aqueous ammonia solution effective to neutralize the final composition to a pH of at least about 8.5;
and wherein the weight percentage of water in the aqueous reaction medium relative to the total weight percentages of reactants (a)-(e) is between about 40 weight % to about 65 weight %.

3. The flame-retardant composition of claim 2, wherein:
(a) the nonyl phenol ethoxylate contains between about 9 to about 12 moles of ethylene oxide;
(b) the phosphate ester is formed by phosphating an alkyl phenyl ethoxylate and/or an alcohol ethoxylate of the formula:
CH₃(CH₂)ₓO(CH₂CH₂O)_{y}H
where x is a value from 5 to 15, and y is a value from 5 to 10;
(c) the ammonium polyphosphate is a Phase II ammonium polyphosphate having the formula [NH₄ PO₃]_{z}, where z is a value from 20 to 1,000; and
(d) the acrylic emulsion copolymer is an aqueous suspension of a linear copolymer of methacrylic acid and acrylic and methacrylic acid esters and has a molecular weight of several million.

4. The flame-retardant composition of claim 3, wherein:
(1) the alkylphenol ethoxylate is a nonyl phenol ethoxylate which contains between about 9 to about 12 moles of ethylene oxide;
(2) the phosphate ester is a monodecyl phosphate ester which contains about 6 moles of ethylene oxide and 9 mol phosphated nonyl phenol;
(3) the weight percentage of 28% ammonia is about 0.30%;
and wherein the weight percentage of water in the aqueous reaction medium relative to the total weight percentages of reactants (a)-(e) of claim 3 is between about is about 40 weight % to about 60 weight %.

5. The flame-retardant composition of claim 1, wherein the flame-retardant composition is made by a process comprising reacting the following reactants in an aqueous reaction medium:
(a) about 7 weight % to about 8 weight % of an octyl or nonyl phenol ethoxylate which contains between about 9 to 12 moles of ethylene oxide;
(b) about 2 weight % to about 3 weight % of a phosphate ester selected from the group consisting of a monodecyl phosphate ester, didecyl phosphate ester, and tridecyl phosphate ester, wherein the monodecyl phosphate ester, didecyl phosphate ester, and tridecyl phosphate ester each contain about 5 to about 10 moles of ethylene oxide;
(c) about 25 weight % to about 50 weight % of a Phase II ammonium polyphosphate of the formula [NH₄ PO₃]_{z}, where z is a value from 20 to 1,000;
(d) about 1.0 weight % to about 2.5 weight % of an acrylic emulsion copolymer that comprises an aqueous suspension of a linear copolymer of methacrylic acid and acrylic and methacrylic acid esters and that has a molecular weight of several million; and
(e) an amount of an aqueous ammonia solution effective to neutralize the final composition to a pH of at least about 8.5;
and wherein the weight percentage of water in the aqueous reaction medium relative to the total weight percentages of reactants (a)-(e) is between about 40 weight % to about 60 weight %.

6. The flame-retardant composition of claim 1, wherein the flame-retardant composition is made by a process comprising reacting the following reactants in an aqueous reaction medium:
(a) about 7.75 weight % of a nonyl phenol ethoxylate containing about 9 moles of ethylene oxide;
(b) about 2.85 weight % of a monodecyl phosphate ester which contains 6 moles of ethylene oxide;
(c) about 25 weight % of a Phase II ammonium polyphosphate of the formula [NH₄ PO₃]_{z}, where z is a value from 20 to 1,000;
(d) about 1.0 weight % to about 2 weight % of ACRYSOL® ASE 95 or ACRYSOL® ASE 60; and
(e) an amount of an aqueous ammonia solution effective to neutralize the final composition to a pH of at least about 8.5;
and wherein the weight percentage of water in the aqueous reaction medium relative to the total weight percentages of reactants (a)-(e) is between about 40 weight % to about 60 weight %.

7. The flame-retardant composition of claim 1, wherein the flame-retardant composition is made by a process comprising reacting the following reactants in an aqueous reaction medium:
(a) about 7.75 weight % of a nonyl phenol ethoxylate containing about 9 moles of ethylene oxide;
(b) about 2.85 weight % of a monodecyl phosphate ester which contains 9.5 moles of ethylene oxide;
(c) about 32 weight % of a Phase II ammonium polyphosphate of the formula [NH₄ PO₃]_{z}, where z is a value from 20 to 1,000, or is more preferably is a value from 500 to 1,000;
(d) about 0.1 weight % to about 2.5 weight % of ACRYSOL® ASE 95 or ACRYSOL® ASE 60; and
(e) an amount of an aqueous ammonia solution effective to neutralize the final composition to a pH of at least about 8.5;
and wherein the weight percentage of water in the aqueous reaction medium relative to the total weight percentages of reactants (a)-(e) is between about 40 weight % to about 60 weight %.

8. The flame-retardant composition of claim 1, wherein the flame-retardant composition is made by a process comprising reacting the following reactants in an aqueous reaction medium:
(a) about 7.75 weight % of a nonyl phenol ethoxylate containing about 9 moles of ethylene oxide;
(b) about 2.84 weight % of a monodecyl phosphate ester which contains about 6 moles of ethylene oxide;
(c) about 25.17 weight % of a Phase II ammonium polyphosphate of the formula [NH₄ PO₃]_{z}, where z is a value from 20 to 1,000, or is more preferably is a value from 500 to 1,000;
(d) about 1.6 weight % of ACRYSOL® ASE 95; and
(e) about 0.30 weight % of 28 weight % aqueous ammonia;
and wherein the weight percentage of water in the aqueous reaction medium relative to the total weight percentages of reactants (a)-(e) is between about 40 weight % to about 60 weight %.

9. The flame-retardant composition of claim 1, wherein the flame-retardant composition is made by a process consisting essentially of reacting the following reactants in an aqueous reaction medium:
(a) about 7.75 weight % of a nonyl phenol ethoxylate containing about 9 moles of ethylene oxide;
(b) about 2.84 weight % of a monodecyl phosphate ester which contains about 6 moles of ethylene oxide;
(c) about 25.17 weight % of a Phase II ammonium polyphosphate of the formula [NH₄ PO₃]_{z}, where z is a value from 20 to 1,000;
(d) about 1.6 weight % of ACRYSOL® ASE 95; and
(e) about 0.30 weight % of 28 weight % aqueous ammonia;
and wherein the weight percentage of water in the aqueous reaction medium relative to the total weight percentages of reactants (a)-(e) is between about 40 weight % to about 60 weight %.

10. The flame-retardant composition of claim 1, wherein the flame-retardant composition is made by a process comprising:
(a) heating water in a reaction vessel to a temperature of greater than about 95° F. to about 100° F.;
(b) thereafter, adding the alkyl phenol ethoxylate, preferably nonyl phenol ethoxylate to the heated water in the reaction vessel and agitating the mixture of heated water and alkyl phenol ethoxylate until the mixture is clear;
(c) thereafter, adding the phosphate ester to the clear mixture of heated water and alkyl phenol ethoxylate, preferably nonyl phenol ethoxylate and agitating the resultant mixture;
(d) thereafter, adding the ammonium polyphosphate to the mixture of monodecyl phosphate ester, heated water and nonyl phenol ethoxylate, wherein the combination of ammonium polyphosphate, phosphate ester, heated water and nonyl phenol ethoxylate is agitated to form a dispersion;
(e) thereafter, under continuous agitation, adding the acrylic emulsion copolymer to the dispersion of ammonium polyphosphate, phosphate ester, heated water and nonyl phenol ethoxylate; and
(f) thereafter, adding ammonia to the acrylic emulsion copolymer-containing dispersion of ammonium polyphosphate, phosphate ester, heated water and nonyl phenol ethoxylate.

11. The flame-retardant composition of claim 10, wherein:
(1) about 7.75 weight % of a nonyl phenol ethoxylate containing about 9 moles of ethylene oxide is added in step (b) of claim 10;
(2) about 2.84 weight % of a monodecyl phosphate ester which contains about 6 moles of ethylene oxide is added in step (c) of claim 10;
(3) about 25.17 weight % of a Phase II ammonium polyphosphate of the formula [NH₄ PO₃]_{z}, where z is a value from 20 to 1,000, is added in step (d) of claim 10;
(4) about 1.6 weight % of ACRYSOL® ASE 95 is added in step (e) of claim 10;
(5) an amount of an aqueous ammonia solution effective to neutralize the final composition to a pH of about 9.0 to about 9.5 is added in step (f) of claims 10; and
(6) wherein the weight percentage of water relative to the total weight percentages of ACRYSOL® ASE 95, ammonium polyphosphate, phosphate ester, and nonyl phenol ethoxylate is between about 40 weight % to about 60 weight %.

12. The flame-retardant composition of claim 11, wherein the composition is anionic, contains about 40 weight % solids, and comprises particles that have a size of less than about 4 millimeters when measured with a Hegman gauge.

13. The flame retardant composition according to claim 1 further comprising an effective amount of at least one viscosity reducing agent.

14. A process for making a flame-retardant composition, the process comprising reacting the following reactants in an aqueous reaction medium:
(a) about 6 weight % to about 10 weight % of an nonyl phenol ethoxylate that contains between about 1 to about 20 moles of ethylene oxide;
(b) about 1 weight % to about 5 weight % of a phosphate ester;
(c) about 1 weight % to about 40 weight % of an ammonium polyphosphate of the formula [NH₄ PO₃]_{z}, where z is less than 10,000;
(d) about 0.1 weight % to about 5 weight % of an acrylic emulsion copolymer; and
(e) an amount of an aqueous ammonia solution effective to neutralize the final composition to a pH of about 8.5 to about 10;
wherein the weight percentage of water in the aqueous reaction medium relative to the total weight percentages of reactants (a)-(e) is between about 40 weight % to about 60 weight %.

15. The process of claim 14, wherein the process comprises reacting:
(a) about 7 weight % to about 10 weight %, or about 7.5 weight % to about 8.5 weight %, or about 7.75 weight % of the nonyl phenol ethoxylate;
(b) about 2 weight % to about 5 weight %, or about 2.5 weight % to about 2.85 weight %, or about 2.84 weight %, of the phosphate ester;
(c) about 20 weight % to about 30 weight %, or about 20 weight % to about 32 weight %, or about 20 weight % to about 20 weight %, or about 20 weight % to about 100 weight %, or about 20 weight % to about 50 weight %, or about 20 weight % to about 100 weight %, or about 20 weight % to about 50 weight %, or about 25 weight % to about 28 weight %, or about 25.17 weight %, of the ammonium polyphosphate;
(d) about 1.0 weight % to about 2.5 weight %, or about 1.6 weight % to about 2 weight %, of the acrylic emulsion copolymer;
(e) an amount of an aqueous ammonia solution effective to neutralize the final composition to a pH of about 8.5 to about 10;
and wherein the weight percentage of water in the aqueous reaction medium relative to the total weight percentages of reactants (a)-(e) is between about 40 weight % to about 60 weight %.

16. The process of claim 15, wherein:
(a) the nonyl phenol ethoxylate contains about 9 to about 12 moles of ethylene oxide;
(b) the phosphate ester is formed by phosphating an alkyl phenyl ethoxylate and/or an alcohol ethoxylate of the formula:
CH₃(CH₂)ₓO(CH₂CH₂O)_{y}H
where x is a value from 5 to 15, and y is a value from 5 to 10;
(c) the ammonium polyphosphate is a Phase II ammonium polyphosphate having the formula [NH₄ PO₃]_{z}, where z is a value from 20 to 1,000; and
(d) the acrylic emulsion copolymer is an aqueous suspension of a linear copolymer of methacrylic acid and acrylic and methacrylic acid esters that has a molecular weight of several million.

17. The process of claim 16, wherein:
(1) the nonyl phenol ethoxylate contains between about 9 to about 12 moles of ethylene oxide;
(2) the phosphate ester is a monodecyl phosphate ester which contains 6 moles of ethylene oxide;
(3) the weight percentage of ammonia is that amount effective to raise the pH of the final composition to about 8.5 to about 10;
and wherein the weight percentage of water in the aqueous reaction medium relative to the total weight percentages of reactants (a)-(e) is between about is about 40 weight % to about 60 weight %.

18. The process of claim 14, wherein the process comprises reacting the following reactants in an aqueous reaction medium:
(a) about 7 weight % to about 8 weight % of a nonyl phenol ethoxylate which contains between about 9 to 12 moles of ethylene oxide;
(b) about 2 weight % to about 3 weight % of a phosphate ester selected from the group consisting of a monodecyl phosphate ester, didecyl phosphate ester, and tridecyl phosphate ester, wherein the monodecyl phosphate ester, didecyl phosphate ester, and tridecyl phosphate ester each contain from 5 to 10 moles of ethylene oxide;
(c) about 25 weight % to about 50 weight % of a Phase II ammonium polyphosphate of the formula [NH₄ PO₃]_{z}, where z is a value from 20 to 1,000;
(d) about 1.5 weight % to about 2.5 weight % of an acrylic emulsion copolymer which comprises an aqueous suspension of a linear copolymer of methacrylic acid and acrylic and methacrylic acid esters and which has a molecular weight of several million; and
(e) an amount of an aqueous ammonia solution effective to neutralize the final composition to a pH of about 8.5 to about 10;
wherein the weight percentage of water in the aqueous reaction medium relative to the total weight percentages of reactants (a)-(e) is between about 50 weight % to about 70 weight %.

19. The process of claim 14, wherein the process comprises reacting the following reactants in an aqueous reaction medium:
(a) about 7.75 weight % of a nonyl phenol ethoxylate containing about 9 moles of ethylene oxide;
(b) about 2.85 weight % of a monodecyl phosphate ester which contains 6 moles of ethylene oxide;
(c) about 25 weight % of a Phase II ammonium polyphosphate of the formula [NH₄ PO₃]_{z}, where z is a value from 20 to 1,000;
(d) about 1 weight % to about 2 weight % of ACRYSOL® ASE 95 or ACRYSOL® ASE 60; and
(e) an amount of an aqueous ammonia solution effective to neutralize the final composition to a pH of about 9.0 to about 9.5;
wherein the weight percentage of water in the aqueous reaction medium relative to the total weight percentages of reactants (a)-(e) is between about 40 weight % to about 60 weight %.

20. The process of claim 12, wherein the flame-retardant composition is made by a process comprising reacting the following reactants in an aqueous reaction medium:
(a) about 7.75 weight % of a nonyl phenol ethoxylate containing about 9 moles of ethylene oxide;
(b) about 2.8 weight % of a monodecyl phosphate ester which contains 9.5 moles of ethylene oxide;
(c) about 32 weight % of a Phase II ammonium polyphosphate of the formula [NH₄ PO₃]_{z}, where z is a value from 20 to 1,000;
(d) about 1.5 weight % to about 2 weight % of ACRYSOL® ASE 95 or ACRYSOL® ASE 60; and
(e) an amount of an aqueous ammonia solution effective to neutralize the final composition to a pH of about 9.0 to about 10;
wherein the weight percentage of water in the aqueous reaction medium relative to the total weight percentages of reactants (a)-(e) is between about 45 weight % to about 55 weight %.

21. The process of claim 14, wherein the process comprises reacting the following reactants in an aqueous reaction medium:
(a) about 7.75 weight % of a nonyl phenol ethoxylate containing about 9 moles of ethylene oxide;
(b) about 2.84 weight % of a monodecyl phosphate ester which contains about 6 moles of ethylene oxide;
(c) about 25.17 weight % of a Phase II ammonium polyphosphate of the formula [NH₄ PO₃]_{z}, where z is a value from 20 to 1,000;
(d) about 1.6 weight % of ACRYSOL® ASE 95; and
(e) an amount of an aqueous ammonia solution effective to neutralize the final composition to a pH of about 9.0 to about 9.5;
and wherein the weight percentage of water in the aqueous reaction medium relative to the total weight percentages of reactants (a)-(e) is between about 40 weight % to about 60 weight %.

22. The process of claim 14, wherein the process consists essentially of reacting the following reactants in an aqueous reaction medium:
(a) about 7.75 weight % of a nonyl phenol ethoxylate containing about 9 moles of ethylene oxide;
(b) about 2.84 weight % of a monodecyl phosphate ester which contains about 6 moles of ethylene oxide;
(c) about 25.17 weight % of a Phase II ammonium polyphosphate of the formula [NH₄ PO₃]_{z}, where z is a value from 20 to 1,000;
(d) about 1.6 weight % of ACRYSOL® ASE 95; and
(e) an amount of an aqueous ammonia solution effective to neutralize the final composition to a pH of about 9.0 to about 9.5;
wherein the weight percentage of water in the aqueous reaction medium relative to the total weight percentages of reactants (a)-(e) is between about 40 weight % to about 60 weight %.

23. The process of claim 14, wherein the process comprises:
(a) heating water in a reaction vessel to a temperature of greater than about 95° F. to about 100° F.;
(b) thereafter, adding the nonyl phenol ethoxylate to the heated water in the reaction vessel and agitating the mixture of heated water and nonyl phenol ethoxylate until the mixture is clear;
(c) thereafter, adding the phosphate ester to the clear mixture of heated water and nonyl phenol ethoxylate and agitating the resultant mixture;
(d) thereafter, adding the ammonium polyphosphate to the mixture of monodecyl phosphate ester, heated water and nonyl phenol ethoxylate, wherein the combination of ammonium polyphosphate, phosphate ester, heated water and nonyl phenol ethoxylate is agitated to form a dispersion;
(e) thereafter, slowly adding phosphated nonyl phenol ethoxylate to the dispersion to avoid foam;
(f) thereafter, under continuous agitation, adding the acrylic emulsion copolymer to the dispersion of ammonium polyphosphate, phosphate ester, phosphated nonyl phenol ethoxylate, heated water and nonyl phenol ethoxylate; and
(g) thereafter, adding ammonia to the acrylic emulsion copolymer-containing dispersion of ammonium polyphosphate, phosphate ester, heated water, phosphated nonyl phenol ethoxylate, and nonyl phenol ethoxylate.

24. The process of claim 23, wherein:
(1) about 7.75 weight % of a nonyl phenol ethoxylate containing about 9 moles of ethylene oxide is added in step (b) of claim 22;
(2) about 2.84 weight % of a monodecyl phosphate ester which contains about 6 moles of ethylene oxide is added in step (c) of claim 22;
(3) about 25.17 weight % of a Phase II ammonium polyphosphate of the formula [NH₄ PO₃]_{z}, where z is a value from 20 to 1,000, is added in step (d) of claim 22;
(4) about 1.66 weight % of ACRYSOL® ASE 95 is added in step (f) of claim 22;
(5) an amount of an aqueous ammonia solution effective to neutralize the final composition to a pH of about 9.0 to about 9.5 is added in step (f) of claims 22; and
(6) wherein the weight percentage of water relative to the total weight percentages of ACRYSOL® ASE 2 95, ammonium polyphosphate, phosphate ester, and alkylphenol ethoxylate is between about 40 weight % to about 60 weight %.

25. The process of claim 24, wherein the fire-retardant composition is anionic, contains about 40 weight % solids, and comprises particles that have a size of less than about 4 millimeters when measured with a Hegman gauge.

26. The process of claim 23, wherein the process comprises:
(a) heating about 2,900 pounds to about 3,000 pounds of water in a reaction vessel to a temperature of greater than about 95° F. to about 100° F.;
(b) thereafter, adding about 370 pounds of a nonyl phenol ethoxylate containing about 9 moles of ethylene oxide to the heated water in the reaction vessel and agitating the mixture of heated water and nonyl phenol ethoxylate until the mixture is clear;
(c) thereafter, adding about 15 gallons of a monodecyl phosphate ester which contains 6 moles of ethylene oxide to the clear mixture of heated water and nonyl phenol ethoxylate and agitating the resultant mixture for about 10 to about 15 minutes;
(d) thereafter, adding about 1,200 pounds of a Phase II ammonium polyphosphate of the formula [NH₄ PO₃]_{z}, where z is a value from 20 to 1,000, to the mixture of monodecyl phosphate ester, heated water and nonyl phenol ethoxylate, wherein the combination of ammonium polyphosphate, monodecyl phosphate ester, heated water and nonyl phenol ethoxylate is agitated to form a dispersion;
(e) thereafter, slowly add phosphated nonyl phenol to avoid foam;
(f) thereafter, under continuous agitation, adding about 75 pounds of ACRYSOL® ASE 95 to the dispersion of ammonium polyphosphate, monodecyl phosphate ester, heated water, phosphated nonyl phenol, and nonyl phenol ethoxylate; and
(g) thereafter, adding about 14 pounds of ammonia to the ACRYSOL® ASE 95-containing dispersion of ammonium polyphosphate, monodecyl phosphate ester, heated water, phosphated nonyl phenol, and nonyl phenol ethoxylate.

27. The process according to claim 14 wherein an effective amount of a viscosity reducing agent is added to said composition.

28. The process according to claim 27 wherein said viscosity reducing agent is added to said final composition.

29. The process according to claim 14 wherein an effective amount of diammonium phosphate is added to said composition in order to reduce the final viscosity of the composition.

30. The process according to claim 29 wherein said diammonium phosphate is added in the step before the addition of ammonium polyphosphate.

31. A fabric, textile, plastic, or article of manufacture which has been treated with a fire-retardant composition of claim 1.

32. A fabric, textile, plastic, or article of manufacture which incorporates a fire-retardant composition of claim 1.

33. The fabric, textile, plastic, or article of manufacture of claim 31, wherein the fabric, textile, plastic, or article of manufacture satisfies NFPA-701 standards.

34. The fabric or textile according to claim 31 which satisfies NFPA-705 standards.

35. A method of treating a fabric, textile, plastic, or article of manufacture, the method comprising applying to the fabric, textile, plastic, or article of manufacture with a fire-retardant composition of claim 1, wherein, subsequent to treatment, the fabric satisfies NFPA-701 standards.

36. The method according to claim 35 wherein said fabric or textile satisfies NFPA-705.
